(19) United States
(12) Patent Application Publication
(10) Pub. No.: US 2011/0281010 A1
(43) Pub. Date: Nov. 17, 2011

(54) Gluten-free bread, milk free, egg free, sugar free bread by Clarissa

(75) Inventor: Clarissa Parry, Simi Valley, CA (US)

(73) Assignee: Clarissa Parry, Simi Valley, CA (US)

(21) Appl. No.: 12/780,836

(22) Filed: May 14, 2010

(51) Int. Cl. A21D 13/06

(52) U.S. Cl. 426/549

(57) ABSTRACT

I have Celiac Disease and must make my own bread. After researching the Market, I could not find any breads available to meet these dietary needs of people with specific illnesses of Autism, Diabetic's, and Celiac Disease. In addition, there was not one recipe available covering these four major consumer groups for safe bread that also tasted like bread should taste. Families with Autistic, Diabetic, and Celiac children, find it especially difficult to feed their families with reasonably priced foods. I worked all winter 2009 to design this bread to meet the requested needs of a gluten-free, milk free, casein free, egg free, and sugar free bread. As a gluten-free bakery having Celiac Disease, it is my responsibility to have designed this new matter (bread), and get it on the market so people like me can afford it.

### BACKGROUND OF INVENTION

People with specific illnesses find it very difficult to find safe foods to eat, specifically bread. Many individuals have contacted me and seriously requested I not only make my gluten-free bread but to please, please make a Diabetic Bread and an Autistic Bread, a Celiac Bread and a Vegan Bread! There was not one recipe available covering four major consumer groups for a safe bread that also tasted like bread should taste. After many baking trials, I came up with this new matter to assist families with Autistic, Diabetic, and Celiac children, to feed their families. I worked all winter 2009 to design this bread to meet the requested needs of a gluten-free, milk free, egg free and sugar free bread. I just want to get it out to the families that need it and get a Utility Patent to protect the ingredients and continue to keep it a safe food for all consumers.

I have bought many items that said they were gluten-free and huge companies only interested in the money, don't understand the hidden gluten and other ingredients that would make those that are Diabetic, Autistic and Celiac sick or upset a Vegan. Please may I have a Utility Patent on my SafeBread?

### BACKGROUND OF THE INVENTION

I, Clarissa Parry have invented a new design for a SafeBread baked by my company Parry's Gluten-Free Bakery and this bread is, Gluten-Free, Milk/Casein Free, & Egg Free Bread as set forth in the following specification:
Step. 1 substitute orange juice for milk
Step. 2 substitute Chia Seeds for eggs
Step. 3 substitute Garbanzo bean flour for Wheat flour
Step. 4 substitute Fava bean flour for Wheat flour
Step. 5 substitute Sorghum bean flour for Wheat flour

### Recipe: Safebread

### Gluten-Free, Milk/Casein Free, & Egg Free Bread

### Ingredients:

3 cups gluten free flour
1⅔ orange juice (110*)
1½ tsp yeast
4 tab chia seeds to 1 cups water—mix last
¾ cup vegetable oil
3 tab flax seeds
1 tsp Xanthan
1/2 tsp Lecithin
1/2 tsp guar gum
1 tsp. apple cider vinegar
½ tsp evaporated cane juice

### Directions

1. Sift flour and place all dry ingredients into mixer bowl. And mix for at least five minutes. Helps to make GF flours happy.
2. Proof the Smart and Final Rapid Rise Yeast with Orange juice for 7 minutes.
3. While yeast is proofing: mix oil, water and remaining orange juice maintaining the temperature at 100*.
4. Once yeast is ready pour into other liquids.
5. Slowly add dry ingredients into mixer bowl.
6. Prepare Chia Seeds and mix one minute.
7. Pour Chia Seeds into main bread mixture.
8. Mix for 2 minutes on medium and 3 minutes on high.
9. Scoop 21 oz. of dough into two half French paper bread pans and place in oven.
10. Keep at least 85 degrees.
11. Let Rise 30 to 35 minutes.
12. Bake at 350 degrees for 45 to 50 minutes.

This Utility Patent does not contain any new matter. It has been added back in this submission. At no time during the Patent process has anything changed. There has not been any new ingredient's added to this matter.

The title of this new matter is “SafeBread,” because with Celiac Disease and other illness's such as Diabetes, Autism, and egg allergies, many companies just mix ingredients they feel will make a product without researching what individual ingredients can do to a persons body.

Ingredients such as, canola oil and buckwheat can still make a person with Celiac Disease ill. This new bread does not only have safe ingredients for Celiac's, Diabetic's, Autistic's, Vegan and egg allergies, it is a product that will help in the healing process of their bodies.

Almost every product on the market had some kind of gluten in it I was asked by many customers to make a bread like my current gluten-free bread that was also milk/casein free for Autism, low sugars for Diabetics, and egg free for egg allergies and Vegan's. At first, I said, I didn't make a bread of that request and then research it to find out that there was no bread available on the market to meet these needs. I worked all winter of 2010 to design a bread (one recipe) that would meet these consumers requests. After many mishaps, I was successful.

### CROSS-REFERENCE TO RELATED APPLICATIONS

There's are no other applications for “SafeBread,” submitted.

### STATEMENT REGARDING FEDERALLY SPONSORED RESEARCH OR DEVELOPMENT

There has never been any Federally, sponsored research assistance or development of this new matter, titled, “SafeBread.”

### THE NAMES OF THE PARTIES TO A JOINT RESEARCH AGREEMENT

There are no parties to a joint research agreement.

### SEQUENCE LISTING

There are no Sequence Listing, results in the research and testing of “SafeBread.”

### BACKGROUND OF THE INVENTION

I have Celiac Disease and many other consumers who know about my Gluten-Free Bread, have requested I create in addition to my Gluten-Free Bread, new breads for their Medical needs of a Diabetic Bread (low sugar), Autistic Bread (no milk/casein) and Vegan Bread (no eggs) for egg allergies. I along with others of medical needs, find it very difficult to find food that is safe to eat and is something we can afford. I have designed this one new bread (matter) to meet all the medical needs requested. A bread like this does not exist anywhere. We need a safe bread, with a decent price on the market for those of us that seriously need it. So the name of this new bread is called Safe Bread. My promise is to keep it down in cost. One health food store chain has their Gluten-Free Bread at $9.99 for one loaf and it is not specialized like my bread in meeting the medical needs of four major consumers. I know it sounds stupid as it's just another loaf of bread, however, it is a life saving loaf of bread! I can make a difference by keeping this matter made with medically safe ingredients and keep it out of the hands of stockholders who raise the price beyond the average consumers ability to purchase.

### BRIEF SUMMARY OF THE INVENTION

### “SafeBread”

The exact nature of this new matter, new bread, is to aide in the healing process through daily nutrition with a safe bread for consumption. The invention pertains to a new type of bread designed to meet the needs of those with life threatening diseases such as Diabetes, Celiac's, Autism, egg allergies and numerous other illnesses that modern science has been discovering in recent years, and the dangers of gluten in the humans daily diet. The unusual grains used to bake this new staff of life (bread) are difficult to use and are not widely available for purchase at the normal prices of regular bread ingredients. People who are being diagnosed with new diseases that require a gluten-free diet are fearful of buying the wrong grains to bake bread and continue to eat the wrong bread or starve. According to National research there are 50 million people with allergies. Shockingly, many of these new patients are discovering they can no longer eat the normal grains we have always assumed were safe and healthy for all humans.

Many companies are trying to bring gluten-free foods to the market, however, if they don't have the understanding of all gluten grains, like the designer of this product, dangerous glutens are still getting into these products.

The purpose of the invention of this new bread is that Clarissa Parry herself has Celiac Disease and can tell immediately if she has consumed gluten. Through re-learning how to eat and prepare safe foods, she has learned the characteristics of gluten-free flours. In addition, she has had many requests to go to extra efforts to not only bake gluten-free bread, but to bake a gluten-free bread, that was also milk/casein free for Autism, low sugars for Diabetes, egg free for Egg Allergies with all safe grains. It took nearly a year testing out many types of gluten-free flours, that would happily work with orange juice and chia seeds. This new bread will assist in the healing process of those with different diseases and allow them to regain their strength once again.

### BRIEF DESCRIPTION OF THE ONE VIEW OF THIS DRAWING, PAGE 15

FIG. 1 Shows the side view of the standard shape of a loaf of bread. It is the ingredients that have been explained in detail the purpose of this new matter.

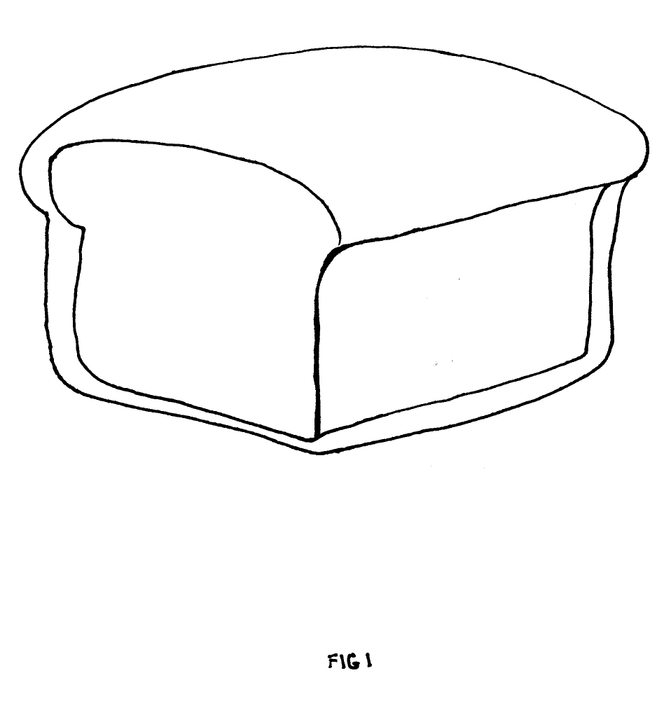

In this drawing, it shows the new bread dough matter baked in a standard bread pan. However, this bread is not any standard type of bread. It is a medically required bread to sustain life for those of Celiac Disease, Diabetes, Autism and Vegan or egg allergies. It is most probable that those suffering from Alzheimer's, Schizophrenia, IBS, Arthritis Asthma and other illnesses related to consuming wheat and gluten that continues to make them sick, will use this bread once it is on the market and they are aware of it's availability. The baking of this bread is very difficult as the gluten-free flours when mixed with eggs and milk are much more happy than the SafeBread made in this Patent Application. Bread being made without milk/casein and eggs tends to take twice as long to cook, is heavier and often falls like a soufflé. It is the type of bread that would frustrate the normal consumer that has never baked any kind of bread. It really needs to be baked in large quantities, as there are, according to the Asthma and Allergy Foundation of America, 50 million Americans have allergies.

However, simple looking this picture is, it is a very important new matter and would be something that companies would like to sell at a higher rate, due to the special recipe. This is my goal to keep that from happening, to stand up the companies that raise prices on items that sustain life.

### DETAILED DESCRIPTION OF THE INVENTION

I have Celiac Disease and many other consumers who know about my Gluten-Free Bread, have requested I create in addition to my Gluten-Free Bread, new breads for their Medical needs of Diabetic Bread (low sugar), Autistic Bread (no milk/casein) and Vegans or Egg free bread due to egg allergies. I along with others of medical needs, find it very difficult to find food that is safe to eat and is something we can afford. I have designed this one new bread (matter) to meet all the medical needs requested. This bread does not exist anywhere, and it is my promise to keep it down in cost. One health food store chain has their Gluten-Free Bread at $9.99 for one loaf and it is not specialized like my bread in meeting the medical needs of four major consumers. I can make a difference by keeping this matter made with medically safe ingredients and keep it out of the hands of stockholders who raise the price beyond the average consumer. I pray thee that I may be issued this Utility Patent so that I may server my fellow man/woman.

### APPENDIX

§1.77 Arrangement of application elements.
(a) The elements of the application are in the following order:
(1) Utility application transmittal form.
(2) Fee transmittal form.
(3) Application data sheet
(4) Specification.
(5) Drawings.
(6) Executed oath or declaration.
(b) The specification include (per USPTO) the following sections in order:
(1) Title of the invention, which may be accompanied by an introductory portion stating the name, citizenship, and residence of the applicant (unless included in the application data sheet).
(2) Cross-reference to related applications (unless included in the application data sheet).
(3) Statement regarding federally sponsored research or development.
(4) The names of the parties to a joint research agreement.
(5) Reference to a “Sequence Listing.”
(6) Background of the invention.
(7) Brief summary of the invention.
(8) Brief description of the one view of the drawing.
(9) Detailed description of the invention.
(10) A claim or claims.
(11) Abstract of the disclosure.

1. What I claim as my invention is a new matter for a new medically required bread to be know as safebread.”: This bread does not exist anywhere in any grocery store and it does not exist in any specialty food stores know as health Food Store's. I am fulfilling the request of many customers who have requested a medically, required bread that also taste like bread should taste like, delicious and satisfying. I designed the new matter and seek approval from the USPTO for a Utility Patent for my Vegan Gluten-free, milk/Casein free, egg free and sugar free SafeBread. I claim this new matter/bread, on recipe I created, is safe for Autistic's, Diabetic II, Vegan, and Celiac Consumers. I claim this new matter when baked provides a medium size loaf of brad, weighing 21 oz., size 7.5×2.5, and toast up like regular wheat breads.
